(19) United States
(12) Patent Application Publication
(10) Pub. No.: US 2012/0134842 A1
(43) Pub. Date: May 31, 2012

(54) WIND WHEEL

(76) Inventor: Walter Freller, Mondsee (AT)

(21) Appl. No.: 13/389,019

(22) PCT Filed: Aug. 5, 2010
(86) PCT No.: PCT/AT2010/000284

§ 371 Date: Feb. 10, 2012

(30) Foreign Application Priority Data
Aug. 7, 2009 (AT) A 1251/2009

(51) Int. Cl. F03D 11/00

(52) U.S. Cl. 416/244 R

(57) ABSTRACT

A wind wheel having a vertical axis of rotation (7) is described, comprising a rotor (1) with a vertical shaft (2) and at least one support arm (4) which extends diametrically to the shaft (2) and is provided with blades (5) on both sides of the shaft (2) and is rotatably supported about the longitudinal axis thereof relative to the shaft (2), with the blades (5) on both sides of the shaft (2) being arranged at an angular offset from each other about the longitudinal axis of the support arm (4) and having a centroid of their areas of wind attack which lies at a radial distance from the longitudinal axis of the support arm (4). In order to achieve advantageous blade adjustments it is proposed that the blades (5) are mounted on the support arm (4) thereof so as to be rotatable about an axis (9) perpendicular to the radial distance of the centroid and to the longitudinal axis of the support arm (4).

### 1. FIELD OF THE INVENTION

The invention relates to a wind wheel having a vertical axis of rotation, said wind wheel comprising a rotor with a vertical shaft and at least one support arm which extends diametrically to the shaft and is provided with blades on both sides of the shaft and is rotatably supported about the longitudinal axis thereof relative to the shaft, wherein the blades on both sides of the shaft are arranged at an angular offset from each other about the longitudinal axis of the support arm and have a centroid of the areas of wind attack which lies at a radial distance from the longitudinal axis of the support arm.

### 2. DESCRIPTION OF THE PRIOR ART

Wind wheels with a vertical axis of rotation have a revolving area in the direction of the wind and one against the direction of the wind, which requires special measures in the revolving area against the wind in order to keep the wind torque in this area of the revolving direction as small as possible. For this purpose it is known to provide the wind wheel with blades which form a flow profile and which can be adjusted about axes which are parallel to the vertical axis of rotation. A control device is used to position the incidence of the blades depending on their position along the orbit in relation to the wind in such a way that the flow of the wind leads to a torque which is advantageous for the propulsion of the wind wheel. The disadvantageous aspect in these known wind wheels is especially the complexity caused by the actuators for the blades and the triggering of the said actuators.

In order to avoid such complexity of the controls it is already known (WO 89/11595 A2) to mount the support arms for the blades rotatably about their longitudinal axis and to arrange the blades on both sides of each shaft at an angular offset against one another about the longitudinal axis of the support arm, so that the centroid of the areas of wind attack of these blades lies at a radial distance from the longitudinal axis of the support arm. As a result of these measures, the blades of the rotor which are not loaded by wind assume a gravity-induced idle position as a result of the free rotatability of the support arm that accommodate said blades, in which position they are symmetrically opposite of one another in a projection in the direction of the longitudinal axis of their support arm with respect to a plane passing through the axis of rotation of the wheel and the longitudinal axis of the support arm, because they lead to opposite weight moments about the support arm axis due to the radial distance of their centroids from the longitudinal axis of the support arm. The wind moments with respect to the longitudinal axis of the support arm which occur as a result of a wind load act in opposite directions on the blade in the revolving area with the wind and on the blade in the revolving area against the wind in the same direction relative to the respective weight moment, which leads to the consequence that the blades with the support arm are rotated about its longitudinal axis in such a way that in the revolving area with the wind they are pivoted into the wind and in the revolving area against the wind they are pivoted out of the wind, as a result of which the necessary reconfiguration of the blades between the two revolving areas which are opposite of one another with respect to the wind direction occurs automatically without any external control implementation. During the passage of the support arm through the direction of wind during its rotation about the vertical axis of rotation, the blades which are connected with each other by the support arm will pivot around, so that the blade revolving from the area of upwind into the area of downwind will be pivoted into the wind and the opposite blade reaching the upwind area will be pivoted out of the wind as a result of the connection of the two blades which is torque-proof concerning the support arm axis. The connection of the blades with the associated support arm which is fixed with respect to the rotation of the support arm causes a pivoting of the blades about the support arm axis into and out of the wind in connection with the mutual angular offset of the blades with respect to the longitudinal axis of the support arm during the rotation of the rotor; however, the blades are also rotated in and out of the wind along their orbit about the vertical axis of rotation of the wind wheel, which comes with the disadvantage that especially in the transitional area between the downwind and upwind area of the orbit the propulsion moment cannot be utilized advantageously.

### SUMMARY OF THE INVENTION

The invention is therefore based on the object of providing a wind wheel of the kind mentioned above with comparatively simple constructive means in such a way that especially in the transitional region between the downwind and upwind area of the orbit a respective propulsion moment can be ensured.

This object is achieved by the invention in such a way that the blades are supported on the support arm thereof so as to be rotatable about an axis perpendicular to the radial distance of the centroid and to the longitudinal axis of the support arm.

As a result of this measure, the individual blades can be kept in a position by the wind itself which allows a favorable utilization of the wind attack areas because the blades are twisted on the downwind side of the orbit through the wind in opposite direction to the rotor about their articulation axes in such a way that they are moved with respect to the axis of rotation of the rotor parallel to themselves along the orbit, but obviously also follow the pivoting movement of the support arm about its longitudinal axis. As a result of this additional rotation in opposite direction to the rotor, the flow moves against the blades transversely to their wind attack area irrespective of the rotational position of the rotor, leading on the downwind side of the orbit to advantageous pressurization conditions for the wind wheel.

For the purpose of a freely rotatable mounting of the blades about an axis which is perpendicular to the radial distance of the centroid and to the longitudinal axis of the support arm, the support arms can comprise at their ends mutually angularly offset bearing yokes, in which the blades are mounted by way of axle journals for example. Despite the free rotating capability of the blades about this axis, the torsion-proof connection of the blades relative to the longitudinal axis of the support arms remains a precondition for the adjustment of the blades with the support arms. Another possibility for mounting the blades is provided when the blades comprise two sections which are disposed on both sides of the support arms and which are mounted with the help of holding brackets on a common axis securing the torsion-proof connection of the blade sections.

### BRIEF DESCRIPTION OF THE DRAWINGS

The subject matter of the invention is shown in the drawings by way of example, wherein:

FIG. 1 shows a wind wheel in accordance with the invention in a schematic side view in the direction of the longitudinal axis of the support arm without wind load;

FIG. 2 shows the wind wheel according to FIG. 1 in a top view with wind load, and

FIG. 3 shows a constructional variant of a wind wheel in accordance with the invention in an illustration corresponding to FIG. 1.

### DESCRIPTION OF THE PREFERRED EMBODIMENTS

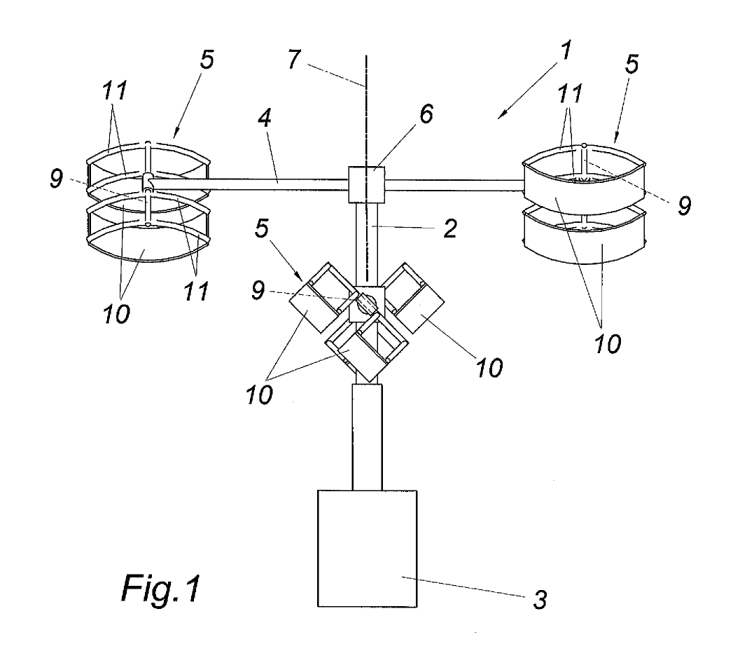

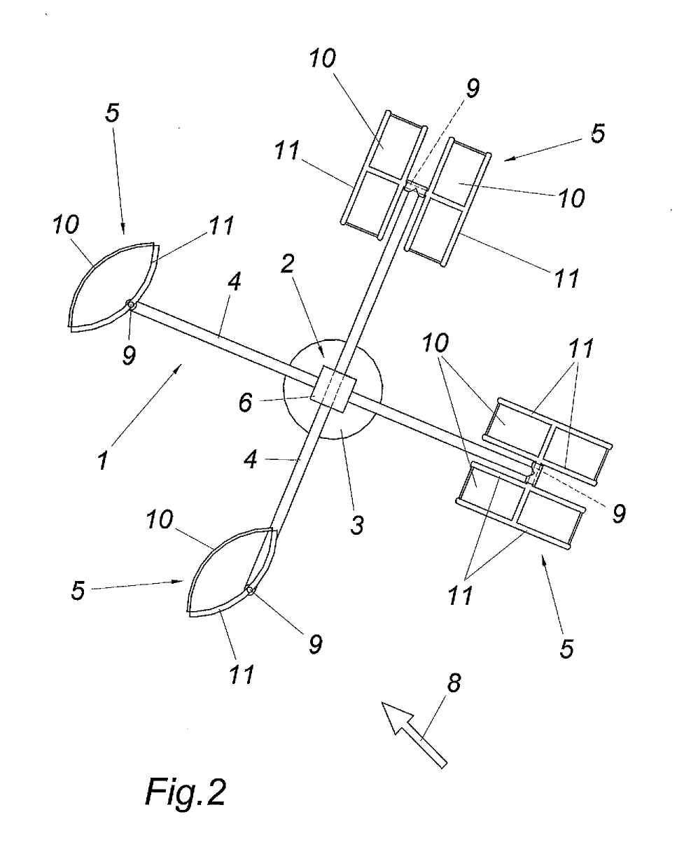

In accordance with the embodiment according to FIGS. 1 and 2, the wind wheel comprises a rotor 1 with a vertical shaft 2 which is rotatably mounted in a housing 3, which advantageously comprises a generator which can be driven with the help of the wind wheel. The rotor 1 is provided with support arms 4 for blades 5, which arms are rotatably mounted with respect to shaft 2. The arrangement has been made in such a way that the support arms 4 penetrate bearing bodies 6 which are arranged on the shaft 2. Since merely the rotatable mounting of the support arms 4 about their longitudinal axes is relevant, different constructional embodiments can be used for the rotatable mounting of the support arms 4 in relation to the shaft 2.

The blades 5 on sides of the support arms 4 which are opposite of one another with respect to the shaft 2 are arranged in an angularly offset manner with respect to the longitudinal axis of the support arms 4, as is shown especially in FIG. 1 in the region of the bottom support arm 4, which extends in the direction of view. This illustration, which corresponds to a projection onto a plane perpendicular to the support arm 4, also shows that the shell-like profiled blades 5 form a wind attack area, the centroid of which is disposed at a radial distance from the longitudinal axis of the support arms 4. As a result of the arrangement of the blades 5 which is eccentric with respect to support arm 4 and their mutual angular distance which is 90° in the illustrated embodiment (which is not mandatory however), the blades 5 will assume a position without wind load in a projection in the direction of the support arms 4 as a result of the free rotating capability of the support arms 4 which is symmetric with respect to a plane extending through the rotational axis 7 and the longitudinal axis of respective support arm 4. This gravity-induced equilibrium position will be cancelled under wind load because the wind load will subject the blades 5 on the opposite sides to a torque in the same direction as a result of the position of their centroids in relation to the support arm 4, which torque rotates the blade downstream of the support arm 4 in the direction of the wind into the wind and the blade upstream of the support arm 4 out of the wind, as is shown in FIG. 2. This means that in the revolving area of the rotor 1 with the wind the blades 5 offer a respectively large wind attack area, but in the revolving area against the wind only a small area of attack. When the support arms 4 pass through the wind direction 8 as indicated in FIG. 2, the support arms 4 will always be rotated in such a way that the blades 5 emerging from the upwind area will be rotated into the wind and the opposite blades 5 which come from the downwind area into the upwind area are twisted out of the wind.

The blades 5 are mounted on the support arms 4 to be rotatable about axes 9. The arrangement has been made in such a way that the axis 9 respectively extends perpendicularly to the radial distance of the centroid of the wind attack area and perpendicularly to the longitudinal axis of support arm 4. As a result of this arrangement, a self-alignment of the blades 5 is achieved with respect to the wind in the revolving area of the rotor 1 without endangering the automatic pivoting of the blades 5 into and out of the wind. As is shown in FIGS. 1 and 2, the blades 5 are respectively subdivided into two sections 10 which are disposed on either side of the support arm 4 and are connected in a torsion-proof manner via the axes 9, so that the blades 5 are able to rotate about 360° about the axes 9 in a manner unobstructed by their support arms. As a result of the alignment of the axes 9, a rotation of the blades 5 about the longitudinal axis of the support arms 4 against the support arms 4 is prevented, so that the automatic reversing by the reciprocating rotation of the support arms 4 during their passage through the wind is not imperiled. The fixing of the blade sections 10 on the blades 5 on the common axis 9 occurs by way of holding brackets 11.

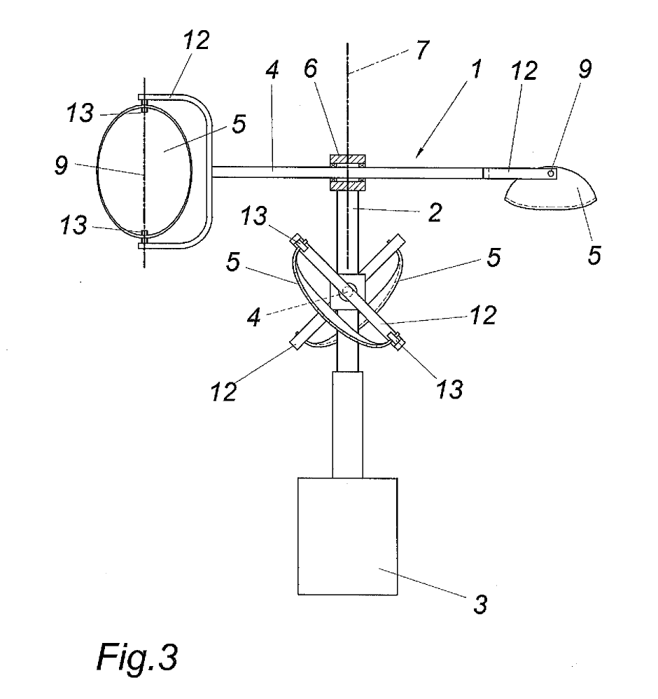

FIG. 3 shows a construction for a wind wheel which is simplified with respect to FIGS. 1 and 2, comprising blades 5 which are mounted in a freely rotatable manner about the axes 9 with respect to the support arms 4. The support arms 4 carry bearing yokes 12 at their ends which are angularly offset with respect to each other and in which the blades 5 are mounted via axle journals 13 which form the axis 9, so that the axis 9 will stand both perpendicularly to the radial distance of the centroid of the wind attack area of the respective blade 5 from the support arm 4 and also perpendicularly to the longitudinal axis of the respective support arm 4. This arrangement also leads to a torque-proof connection with respect to the longitudinal axis of the support arms 4 for the blades 5, which represents a precondition for the adjustment of the blades 5 with the support arms 4 in the bearing bodies 6 in order to rotate the blades 5 in the revolving area with the wind into the wind and in the revolving area against the wind out of the wind during the passage of the support arms 4 through the wind during the rotation of the rotor I about its axis of rotation 7.

1. A wind wheel having a vertical axis of rotation (7), said wind wheel comprising a rotor (1) with a vertical shaft (2) and at least one support arm (4) which extends diametrically to the shaft (2) and is provided with blades (5) on both sides of the shaft (2) and is rotatably supported about the longitudinal axis thereof relative to the shaft (2), with the blades (5) on both sides of the shaft (2) being arranged at an angular offset from each other about the longitudinal axis of the support arm (4) and having a centroid of their areas of wind attack which lies at a radial distance from the longitudinal axis of the support arm (4), wherein the blades (5) are mounted on the support arm (4) thereof so as to be rotatable about an axis (9) perpendicular to the radial distance of the centroid and to the longitudinal axis of the support arm (4).

2. A wind wheel according to claim 1, wherein the support arms (4) comprise bearing yokes (12) at their ends, which yokes are arranged at an angular offset from each other and in which the blades (5) are rotatably mounted.

3. A wind wheel according to claim 1, wherein the blades (5) are subdivided into two sections (10) which are disposed on both sides of the support arms (4) and are connected with each other in a torsion-proof manner via the axes (9).

4. A wind wheel according to claim 3, wherein the blade sections (10) of the blades (5) are connected to the common axis (9) via holding brackets (11).
